(19) United States
(12) Patent Application Publication
(10) Pub. No.: US 2015/0346745 A1
(43) Pub. Date: Dec. 3, 2015

(54) THERMALLY-ADAPTIVE VOLTAGE SCALING FOR SUPPLY VOLTAGE SUPERVISOR POWER OPTIMIZATION

(71) Applicant: QUALCOMM Incorporated, San Diego, CA (US)

(72) Inventors: Sachin Dileep DASNURKAR, San Diego, CA (US); Neha Pramod JOSHI, San Diego, CA (US); Krishna Reddy DUSETY, San Diego, CA (US); Prasad Rajeevalochanam BHADRI, San Diego, CA (US)

(21) Appl. No.: 14/485,629

(22) Filed: Sep. 12, 2014

Related U.S. Application Data
(60) Provisional application No. 62/006,008, filed on May 30, 2014.

(51) Int. Cl. G05F 1/46

(52) U.S. Cl. CPC G05F 1/463

(57) ABSTRACT

Aspects of an integrated circuit (IC) using a scaling voltage are provided. The IC includes a chip section configured to operate using a scaled supply voltage. The IC also includes a sensor configured to measure a temperature of the chip section. The IC also includes an adjustment circuit configured to adjust a supply voltage to a scaled supply voltage, wherein the scaled voltage is based on the measured temperature. Aspects of a testing device for a chip are also provided. The testing device includes a sensor configured to measure an operating frequency of a section of the chip when operating at a defined temperature. The testing device also includes a memory device comprising a scaled voltage table, the scaled voltage table configured to store as an entry the measured operating frequency and the defined temperature.

### CROSS-REFERENCE TO RELATED APPLICATION

This application claims the benefit of U.S. Provisional Application Ser. No. 62/006,008, entitled “Thermally-Adaptive Voltage Scaling for Supply Voltage Supervisor Power Optimization” and filed on May 30, 2014, which is expressly incorporated by reference herein in its entirety.

### TECHNICAL FIELD

Various exemplary embodiments disclosed herein relate generally to electronic circuits. In particular, various embodiments relate to power control circuits.

### BACKGROUND

Electronic devices can comprise a great number of smaller electronic components and circuits. Due to the large number of these smaller electronic components, device behavior may not be consistent across frequencies used during operation. Further, variances in manufacturing cause two devices to act differently due to inherent variances in the materials used.

In order to accommodate for variances between devices, compensation circuits, such as a supply voltage supervisor (SVS) is used to optimize individual circuits based on tested conditions. An SVS can use voltage tables to modify supply voltage for individual electronic circuits across a range of frequencies. However, conventional voltage tables are conservative in their prescribed scaled supply voltages for specific frequencies due to the need to accommodate for the entire frequency range. This can lead to additional voltage margins and higher power consumption that would not be necessary if the voltage tables were more accurate.

In view of the foregoing, it would be desirable to improve use of scaling voltages during operation of electronic circuits. In particular, it would be desirable to improve the accuracy of scaling voltages based on observed circuit operation characteristics.

### SUMMARY

In light of the present need for an improved use of scaling voltages for electronic circuits, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in the later sections.

Aspects of an integrated circuit (IC) using a scaling voltage are provided. The IC includes a chip section configured to operate using a scaled supply voltage. The IC also includes a sensor configured to measure a temperature of the chip section. The IC also includes an adjustment circuit configured to adjust a supply voltage to a scaled supply voltage, wherein the scaled voltage is based on the measured temperature.

In an aspect, the IC can also include a memory device comprising a scaled voltage table, wherein the adjustment circuit is configured to retrieve the scaled supply voltage from the scaled voltage table. In an aspect, the IC can be further configured such that the scaled supply voltage is further based on an operating frequency of at least one circuit in the chip section. In an aspect, the adjustment circuit is further configured to measure the chip section after a defined time interval.

In an aspect the adjustment circuit is configured to determine the scaled supply voltage by:

V_{dd}=V₀+(Tₛₑₜ+Tₛₑₙₛₑ)'S

Where V_{dd} is the scaled voltage, V₀ is a default voltage, Tₛₑₜ is a default temperature, Tₛₑₙₛₑ is a measured temperature, and S is a scaling constant.

Aspects of a testing device for a chip are also provided. The testing device includes a sensor configured to measure an operating frequency of a section of the chip when operating at a defined temperature. The testing device also includes a memory device comprising a scaled voltage table. The scaled voltage table can be configured to store as an entry the measured operating frequency and the defined temperature.

In an aspect, the testing device can be further configured to write the scaled voltage table to the chip. In an aspect, the testing device can be further configured to write the scaled voltage table into read-only memory (ROM) on the chip.

It should be apparent that, in this manner, various exemplary embodiments enable use of improved scaling voltages for an integrated circuit. Particularly, by scaling voltages based on measured temperatures of circuits during operation, an integrated circuit can be optimized to function under known operating conditions instead of conservative estimates based on assumed worst-case scenario presumptions.

### BRIEF DESCRIPTION OF THE DRAWINGS

In order to better understand various exemplary embodiments, reference is made to the accompanying drawings wherein:

FIG. 1 illustrates a wireless device communicating with wireless communications systems;

FIG. 2 illustrates an exemplary integrated circuit that receives a scaled supply voltage;

FIG. 3 illustrates an exemplary scaling voltage table;

FIG. 4 illustrates an exemplary testing apparatus to determine scaling voltages for an integrated circuit;

FIG. 5 illustrates an exemplary method for scaling a supply voltage for a section of an integrated circuit; and

FIG. 6 illustrates an exemplary method for determining scaling voltages for sections of an integrated circuit.

### DETAILED DESCRIPTION

The detailed description set forth below in connection with the appended drawings is intended as a description of various exemplary embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details. In some instances, well-known structures and components are shown in block diagram form in order to avoid obscuring the concepts of the present invention. Acronyms and other descriptive terminology may be used merely for convenience and clarity and are not intended to limit the scope of the invention.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. The term “exemplary” is used herein to mean “serving as an example, instance, or illustration.” Any design described herein as “exemplary” is not necessarily to be construed as preferred or advantageous over other designs.

Several aspects of electronic systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise random-access memory (RAM), read-only memory (ROM), electronically erasable programmable ROM (EEPROM), compact disk (CD) ROM (CD-ROM), or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

The word “exemplary” is used herein to mean serving as an example, instance, or illustration. Any embodiment described herein as “exemplary” is not necessarily to be construed as preferred or advantageous over other embodiments. Likewise, the term “embodiment” of an apparatus, circuit or method does not require that all embodiments of the invention include the described components, structure, features, functionality, processes, advantages, benefits, or modes of operation.

The terms “connected,” “coupled,” or any variant thereof, mean any connection or coupling, either direct or indirect, between two or more elements, and can encompass the presence of one or more intermediate elements between two elements that are “connected” or “coupled” together. The coupling or connection between the elements can be physical, logical, or a combination thereof. As used herein, two elements can be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element.

As used herein, the terms “comprises”, “comprising,”, “includes” and/or “including”, when used herein, specify the presence of the stated features, integers, steps, operations, elements, and/or components, but do not preclude the presence or addition of one or more other features, integers, steps, operations, elements, components, and/or groups thereof.

Various aspects of circuits for an optimized thermally-adaptive voltage-scaled integrated circuit will now be presented. However, as those skilled in the art will readily appreciate, such aspects may be extended to other circuit configurations and devices. Accordingly, all references to a specific application for scaled voltage circuits, or any component, structure, feature, functionality, or process within a thermally-adaptive voltage-scaled integrated circuit are intended only to illustrate exemplary aspects of electronic hardware with the understanding that such aspects may have a wide differential of applications.

Various embodiments of hardware with an installed thermally-adaptive voltage-scaled integrated circuit may be used, such as a mobile phone, personal digital assistant (PDA), desktop computer, laptop computer, palm-sized computer, tablet computer, set-top box, navigation device, work station, game console, media player, or any other suitable device.

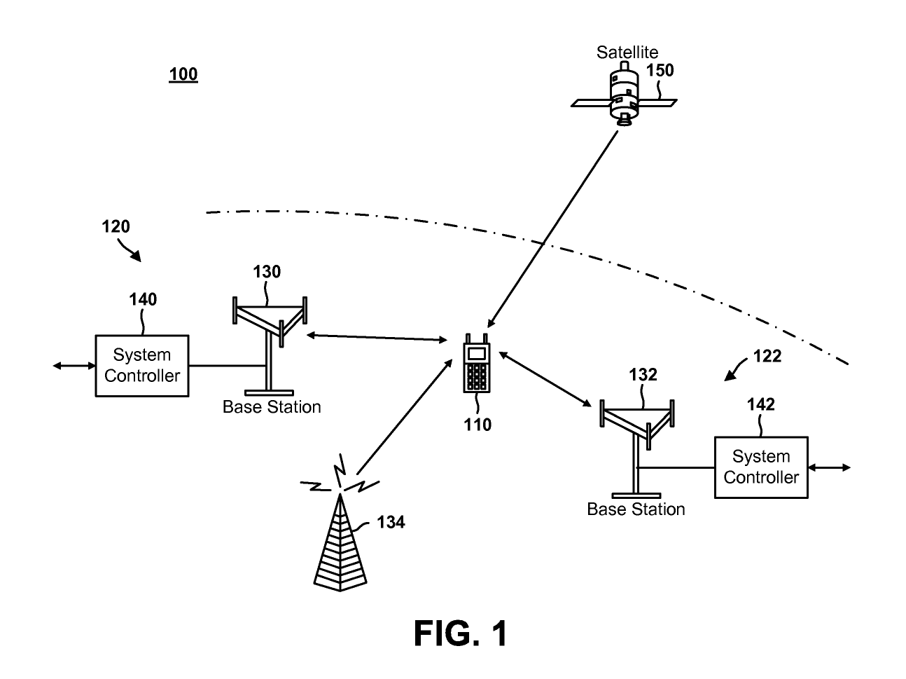

FIG. 1 illustrates a wireless device communicating with different wireless communications systems. FIG. 1 is a diagram 100 illustrating a wireless device 110 communicating with different wireless communication systems 120, 122. Wireless device 110, base stations 130, 132, and system controllers 140, 142 can use a thermally-adaptive voltage-scaled integrated circuit to optimize power consumption of individual components based on operating temperatures, especially when operating at lower frequencies. Alternative uses of thermally-adaptive voltage-scaled integrated circuits in electronic hardware are known to those of skill in the art.

Wireless systems 120, 122 may each be a Code Division Multiple Access (CDMA) system, a Global System for Mobile Communications (GSM) system, a Long Term Evolution (LTE) system, a wireless local area network (WLAN) system, or some other wireless system. A CDMA system may implement Wideband CDMA (WCDMA), CDMA 1X or cdma2000, Time Division Synchronous Code Division Multiple Access (TD-SCDMA), or some other version of CDMA. TD-SCDMA is also referred to as Universal Terrestrial Radio Access (UTRA) Time Division Duplex (TDD) 1.28 Mcps Option or Low Chip Rate (LCR). LTE supports both frequency division duplexing (FDD) and time division duplexing (TDD). For example, wireless system 120 may be a GSM system, and the wireless system 122 may be a WCDMA system. As another example, the wireless system 120 may be an LTE system, and wireless system 122 may be a CDMA system.

For simplicity, diagram 100 shows wireless system 120 including one base station 130 and one system controller 140, and wireless system 122 including one base station 132 and one system controller 142. In general, each wireless system 120, 122 may include any number of base stations and any set of network entities. Each base station 130, 132 may support communication for wireless devices within the coverage of the base station. Base stations 130, 132 may also be referred to as a Node B, an evolved Node B (eNB), an access point, a base transceiver station, a radio base station, a radio transceiver, a transceiver function, a basic service set (BSS), an extended service set (ESS), or some other suitable terminology. Wireless device 110 may also be referred to as a user equipment (UE), a mobile device, a remote device, a wireless device, a wireless communications device, a station, a mobile station, a subscriber station, a mobile subscriber station, a terminal, a mobile terminal, a remote terminal, a wireless terminal, an access terminal, a client, a mobile client, a mobile unit, a subscriber unit, a wireless unit, a remote unit, a handset, a user agent, or some other suitable terminology. Wireless device 110 may be a cellular phone, a smartphone, a tablet, a wireless modem, a personal digital assistant (PDA), a handheld device, a laptop computer, a smartbook, a netbook, a cordless phone, a wireless local loop (WLL) station, or some other similar functioning device.

Wireless device 110 may be capable of communicating with wireless system 120 and/or 122. Wireless device 110 may also be capable of receiving signals from broadcast stations, such as broadcast station 134. Wireless device 110 may also be capable of receiving signals from satellites, such as satellite 150, in one or more global navigation satellite systems (GNSS). Wireless device 110 may support one or more radio technologies for wireless communication such as GSM, WCDMA, cdma2000, LTE, 802.11, etc. The terms “radio technology,” “radio access technology,” “air interface,” and “standard” may be used interchangeably.

Wireless device 110 may communicate with a base station in a wireless system via the downlink and the uplink. The downlink (or forward link) refers to the communication link from the base station to the wireless device, and the uplink (or reverse link) refers to the communication link from the wireless device to the base station. A wireless system may utilize TDD and/or FDD. For TDD, the downlink and the uplink may share the same frequency, and downlink transmissions and uplink transmissions may be sent on the same frequency in different time periods. For FDD, the downlink and the uplink are allocated separate frequencies. Downlink transmissions may be sent on one frequency, and uplink transmissions may be sent on another frequency. Some exemplary radio technologies supporting TDD include GSM, LTE, and TD-SCDMA. Some exemplary radio technologies supporting FDD include WCDMA, cdma2000, and LTE.

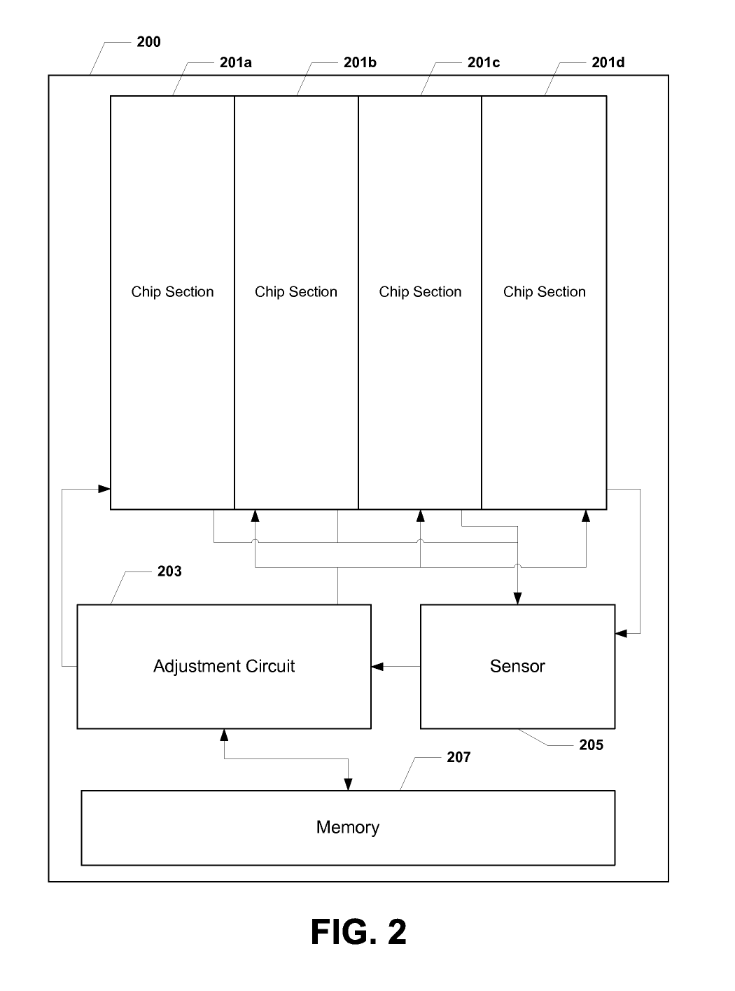

FIG. 2 illustrates an exemplary integrated circuit that receives a scaled supply voltage. Integrated circuit 200 can be a circuit chip and can include multiple chip sections 201a-d that receive supply voltages; these supply voltages can be scaled by adjustment circuit 203 based on at least measured temperatures taken by sensor 205 and scaled voltage adjustment values stored in memory 207. In some embodiments, integrated circuit 200 can comprise a power management integrated circuit (PMIC).

Chip sections 201a-d can be portions (e.g., “cores”) of integrated circuit 200 that include one or more operating circuits. In some embodiments, adjustment circuit 203, sensor 205, and memory 207 can be included in one or more chip sections 201a-d. In some embodiments, each chip section 201a-d can consist of a core, i.e., a discrete component of integrated circuit 200.

Each chip section 201a-d can include a circuit that receives a supply voltage that is used during operation. In some embodiments, a circuit in each chip section 201a-d can use a different voltage supply during operation. For example, a circuit in chip section 201a can operate using a scaled supply voltage of 980 mV, while circuits in chip section 201b, d uses a scaled supply voltages of 700 mV and 1020 mV, respectively. During operation, adjustment circuit 203 can adjust the scaled supply voltages to circuits in each chip section 201a-d independently.

Sensor 205 can comprise one or more sensors that measure characteristics of chip sections 201a-d. In some embodiments, sensor 205 can comprise a plurality of sensors. In such instances, a chip section 201a can include one or more sensors that measure different values for a circuit in chip section 201a, such as operating frequency and temperature. In some embodiments, sensor 205 can connect to multiple chip sections 201a-d. Sensor 205 can comprise one or more of a temperature sensor (e.g., a thermometer), a frequency detector (e.g., a frequency counter), and/or a voltage detector (e.g., a voltmeter). For example, sensor 205 can be an on-chip temperature sensor that can instantaneously measure the temperature of the circuit in chip sections 201a-d. Sensor 205 can poll chip sections 201a-d, taking measurements of specific values at defined times. In the illustrative embodiment, for example, sensor 205 can poll each chip section 201a-d every 10 seconds to measure the operating temperature of circuits included in each chip section 201a-d. In some embodiments, sensor 205 can provide feedback to adjustment circuit 203 to stabilize the scaled supply voltage for a circuit to a target value.

Adjustment circuit 203 can be connected to one or more chip sections 201a-d and adjust supply voltages for circuits included in chip sections 201a-d. In some embodiments, adjustment circuit 203 can send control signals to discrete electronic components, such as adjustable resistors, capacitors, varactors, etc. to adjust a default supply voltage (V_{cc}) to a scaled supply voltage. In some embodiments, adjustment circuit 203 can control one or more switches to adjust the initial supply voltage to the scaled supply voltage.

Adjustment circuit 203 can apply process voltage scaling (PVS) to a circuit in chip sections 201a-d by using either a voltage scaling table or a scaling voltage formula to first determine a scaling voltage before adjusting the default supply voltage to the determined scaling voltage (i.e., the scaled supply voltage). In some embodiments, adjustment circuit 203 can use the scaling voltage formula for PVS when a scaled voltage for the measured temperature is not included in the scaled voltage table. In some embodiments, adjustment circuit 203 can determine the scaled supply voltage based on a measured temperature received from sensor 205. In some embodiments, adjustment circuit 203 can also determine the scaled supply voltage based on other values, such as a known operating frequency or a detected frequency received from sensor 205. In some embodiments, adjustment circuit 203 can account for other operating factors and characteristics, such as operating mode, operating current, etc. when determining the scaled supply voltage.

In some embodiments, adjustment circuit 203 can refrain from adjusting the scaled supply voltage until the temperature or temperature change eclipses a defined threshold. In some embodiments, the threshold can be a defined value, such as when the measured temperature is 60 degrees Celsius (° C.). In other embodiments, the adjustment threshold can be a defined change value (e.g., Δ=2° C.), while in some instances, the adjustment threshold can be a percentage difference (e.g., Δ=±5%).

Memory 207 can be a digital component in integrated circuit 200 or a circuit chip that receives and stores scaling factors used by adjustment circuit 203 when determining scaled supply voltages for circuits in chip sections 201a-d. In some embodiments, memory 207 can comprise non-volatile memory, including read-only memory (ROM), such as an EEPROM or QFPROM that permanently stores entries of a scaling voltage table or constants for a scaling voltage formula.

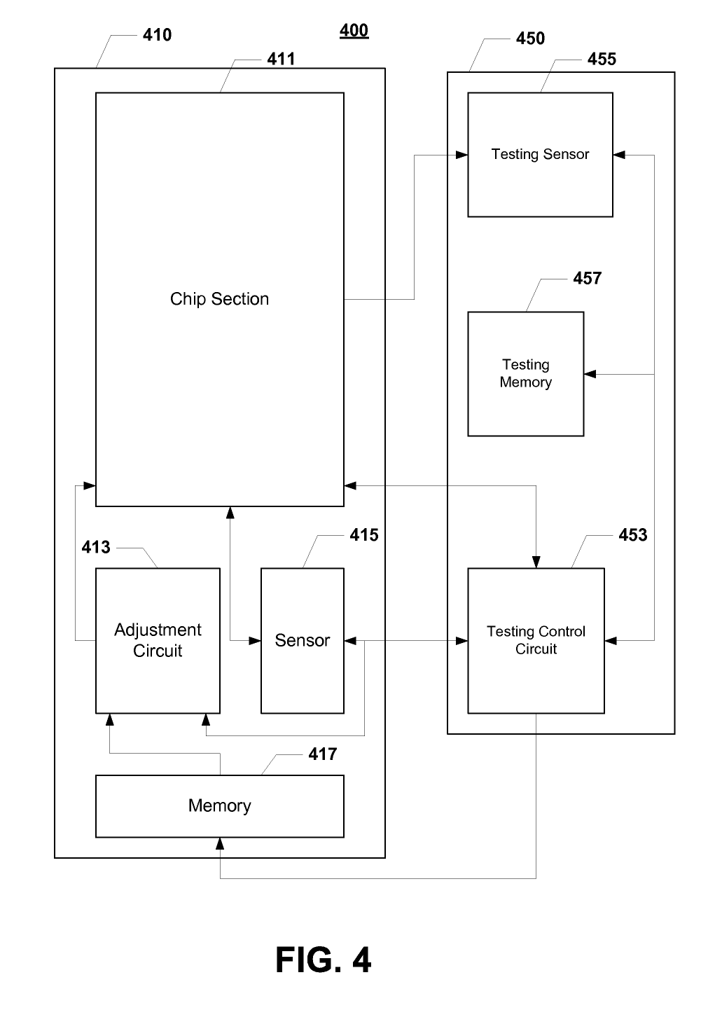

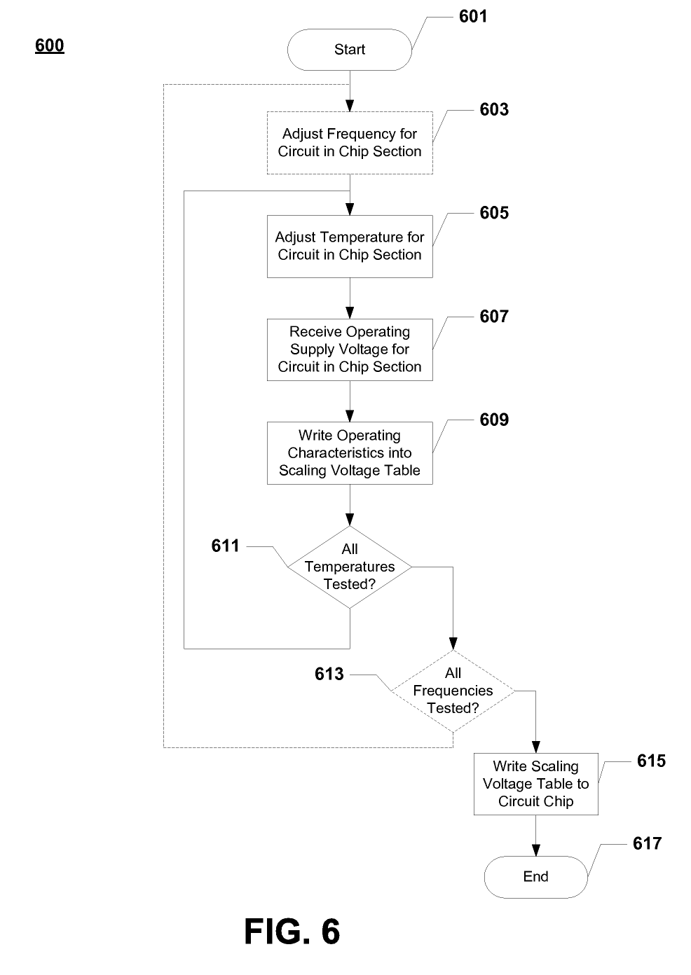

As will be discussed in relation to FIGS. 4 and 6, a testing device can write scaling voltage entries and scaling voltage constants into memory 203 during initial calibration. In such instances, memory 203 can permanently store the values that adjustment circuit 203 later uses while circuits in chip sections 201a-d are in use. In some embodiments, adjustment circuit 203 can add or modify scaling voltage entries for the scaling voltage table or scaling voltage constants for the scaling voltage formula. In such instances memory 203 can comprise a writeable memory that adjustment circuit 203 can access when determining scaling supply voltages.

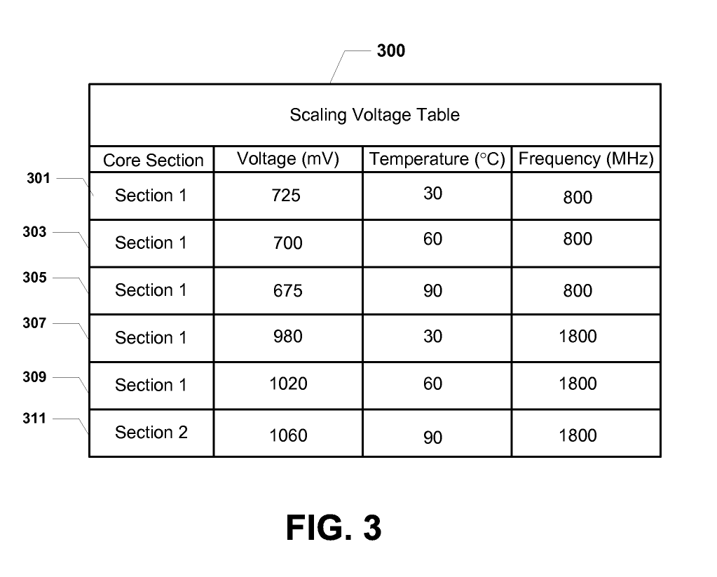

FIG. 3 illustrates an exemplary scaling voltage table. Scaling voltage table 300 can, for example, be stored in memory 207 and accessed by adjustment circuit 203 to provide scaling voltages for target circuits in chip sections 201a-d while the target circuits are in operation. In some embodiments, scaling voltage table can be accessed through software; in such instances, adjustment circuit 203 can include software to access scaling voltage table 300 to determine applicable scaled supply voltages. Scaling voltage table 300 comprises a list of scaling voltage entries 301-311. Each scaling voltage entry 301-311 can include a scaled operating voltage, an operating temperature, and an operating frequency. In some embodiments, each scaling voltage entry 300 can include other values or modes, such as operating mode, operating current, etc. In some embodiments, scaling voltage entries 301-311 can be generated through a testing method that modifies a circuit in a chip section until it is operating at a target temperature and frequency; the operating voltage for the circuit when operating at the target temperature and frequency is the voltage for that entry.

For example, entries 301-309 correspond to different operating values for a circuit in chip section 201a. Scaling voltage entries 301-305 show scaling supply voltages for the circuit operating at a constant frequency over a range of temperatures, while scaling voltage entry pairs 305, 307 show scaling supply voltages for the circuit operating at a constant temperature over different frequencies. The scaling supply voltage values for scaling voltage entries 301-305 fluctuates when operating at the same frequency, as the measured temperature modifies the operating characteristics of the circuit and therefore modifies the optimized scaling supply voltage for the circuit for those particular measured conditions. Similarly, the scaling supply voltage values for scaling voltage entry pairs 305, 307 fluctuates with a common voltage, as the circuit is operating at a different frequency. The effects of using a scaling supply voltage compared to a default supply voltage may be most evident at lower frequencies (e.g., 500-1800 MHz).

FIG. 4 illustrates an exemplary testing apparatus to determine scaling voltages for an integrated circuit. Testing apparatus 400 can include an integrated circuit 410 similar to integrated circuit 200 and a testing device 450. Integrated circuit 410 can include a chip section 411, an adjustment circuit 413, sensor 415, and memory 417 similar to the corresponding components for integrated circuit 200. Testing device 450 can include a testing control circuit 453, a testing sensor 455, and a testing memory 457. Testing device 450 can test and measure chip section 401 to determine operating characteristics for a circuit operating in that section. Testing device 450 can use the measured operating characteristics for the tested circuit to determine scaled supply voltages for the circuit when operating at the tested values. The determined scaled supply voltages can then be supplied to integrated circuit 410 and later used by adjustment circuit 403 to provide a scaled supply voltage for the circuit while it is under operation.

Testing device 450 can be testing equipment like an ATE (automatic test equipment) that implements a testing method for a circuit in chip section 411 to determine a scaled supply voltage for the circuit when operating at a specified temperature and/or frequency. In some embodiments, testing device 450 can measure the scaled supply voltage at set temperature intervals (e.g., every 1° C.) and/or set frequency intervals (e.g., every 100 MHz). Testing device can store the scaled supply voltage along with the associated testing temperature and testing frequency as a scaled supply voltage entry in scaled voltage table 300. Once scaled voltage table 300 is fully populated, testing device 450 can write scaling voltage table to memory 417 in integrated circuit 410.

Testing circuit control 453 can be, for example, a processor, processing system, or integrated circuit, etc. that is connected to testing sensor 455 and testing memory 457. During testing of chip section 411, testing control circuit 453 can also be connected to chip section 411, sensor 415, and memory 417. During testing and calibration, testing control circuit 453 can calibrate the circuit in chip section 411 so that it is operating at a specified temperature and frequency (testing control circuit 453 can ensure that the circuit is operating at the specified temperature and frequency via feedback from testing sensor 455 and/or on-chip sensor 415). In some embodiments, testing control circuit 453 can receive feedback from the circuit in chip section 411 that testing control circuit 453 uses to modify the circuit so it is operating using the desired characteristics.

Testing sensor 455 can include one or more sensors that connect to chip section 411 to measure or determine operating characteristics of the circuit being measured. In some embodiments, testing sensor 455 can include a temperature sensor, a frequency sensor, and/or a voltage sensor that are connected to chip section 411 to measure values while the circuit is in operation. In some embodiments, the groups of measured values can be grouped as a tuple (e.g., {section1, 725 mV, 30° C., 800 MHz}) and can be sent to testing control circuit 453 for feedback and testing memory 457 for storage in scaled voltage table 300 as a scaled supply voltage entry 301-311. Testing memory 457 can include a scaled voltage table 300 that is populated with entries 300-311 as measured during calibration from testing sensor 455. In some embodiments, testing memory 457 can also store constants for the scaled voltage formula:

V_{dd}=V₀+(Tₛₑₜ+Tₛₑₙₛₑ)×S (1)

Where V_{dd} is the scaled supply voltage, V₀ is the default voltage, Tₛₑₜ is a default set temperature, Tₛₑₙₛₑ is a measured temperature, and S is a scaling constant. The scaling constant S can be a de-rating slope with a negative constant of volts per degree Celsius (e.g., S=−0.5 mV/° C.).

Testing memory 457 can, for example, store values for V₀, Tₛₑₜ, and/or S based on one or more sets of measured values for the tested circuit. In some embodiments, circuits in different chip sections 201a-d can have different values for the constants in the scaled voltage formula (1). In some embodiments, testing control circuit 453 can write scaled voltage table 300 and constants for scaled voltage formula (1) to memory 417 of integrated circuit 400.

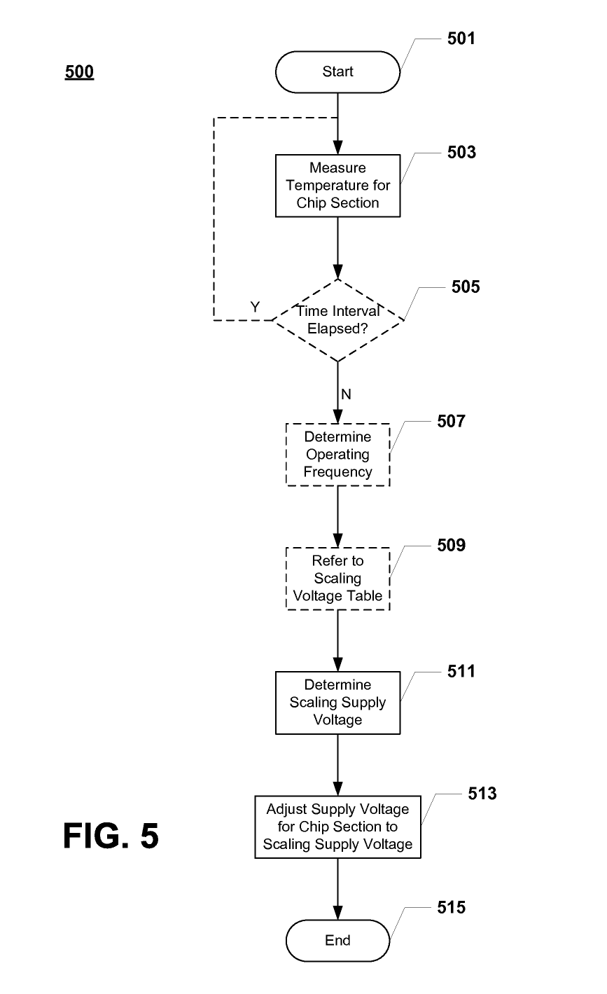

FIG. 5 illustrates an exemplary method for scaling a supply voltage for a section of an integrated circuit. Method 500 can be performed, for example, by adjustment circuit 203 in integrated circuit 200, 410 during operation of a circuit in a chip section 401a. Method 500 can be performed for each of N chip sections 201a-d that comprise integrated circuit 200, 410.

Method 500 can begin at step 501 and proceed to step 503, where a temperature is measured for the chip section 201a while the applicable circuit in chip section 201a is running. In some embodiments, sensor 205 comprises a sensor within chip section 201a that measures the temperature; in some embodiments, sensor 205 is a discrete component external to chip section 201a that measures the temperature for chip section 201a while the circuit is running. In some embodiments, adjustment circuit 203 can optionally proceed to step 505 to determine whether a defined time interval has elapsed. In other embodiments, adjustment circuit can proceed to step 507, 509, or 511.

In step 507, adjustment circuit 505 determines whether a defined time interval has elapsed. For example, adjustment circuit 505 can adjust the supply voltage for a circuit every 10 seconds. In such instances, adjustment circuit at step 505 can determine whether 10 seconds has elapsed. If so, method 500 returns to step 503, where sensor 205 polls the temperature for chip section 201a. Otherwise, adjustment circuit can optionally proceed to step 507.

In step 507, adjustment circuit 203 can determine the operating frequency for the circuit in chip section 201a. In some embodiments, adjustment circuit 203 can determine the operating frequency by receiving a measured frequency from sensor 203. In some embodiments, adjustment circuit 203 determines the operating frequency based on a known mode of operation. For example, a circuit in chip section 201a can be operating in an operating mode that receives communications at a WiFi frequency; if the low-power mode is associated with a specific frequency or frequency band (e.g, 2.4 GHz), adjustment circuit 203 can determine the operating frequency based on the mode of operation. Once the operating frequency is determined, adjustment circuit 203 can optionally proceed to step 509.

Adjustment circuit 203 can, in step 509, refer to scaling voltage table 300. Scaling voltage table 300 can be stored, for example, in memory 207. Adjustment circuit 203 can refer to scaling voltage table 300 to look up a scaling voltage based on at least on the measured temperature received in step 503. In some embodiments, scaled voltage table 300 can include multiple entries for a measured temperature. In such instances, adjustment circuit 203 can use the operating frequency determined in step 507 to find the proper scaled supply voltage corresponding to the measured values. For example, adjustment circuit can refer to scaling voltage table 300 with a measured temperature of 30° C. As scaling voltage table 300 includes scaling voltage entries 301-311 that provide scaling voltages for the measured temperature, adjustment circuit 203 can use the determined operating frequency (e.g., 800 MHz) to filter scaling voltage entries 301-311 to a single entry, e.g., scaling voltage entry 305, that has a scaling supply voltage of 675 mV when the measured temperature is 90° C. and the determined operating frequency is 800 MHz.

In step 511, adjustment circuit 203 can determine a scaling supply voltage for the circuit in chip section 201a. When adjustment circuit 203 finds an applicable scaling voltage entry 305 upon referring to scaling voltage table 300 in step 509, adjustment circuit can determine the scaling supply voltage by retrieving the scaled voltage value from the applicable scaled supply voltage entry 305. Alternatively, when adjustment circuit 203 did not refer to scaling voltage table 300 in step 509 or when scaling voltage table 300 did not have an scaled voltage entry 301-311 for the measured value, adjustment circuit 203 can determine the scaled supply voltage using the scaled voltage formula. In such instances, adjustment circuit 203 can retrieve scaling constants used in the scaled voltage formula from memory 207 and measured values received from sensor 205 to produce the scaled supply voltage.

Once the scaled supply voltage is determined in step 511, adjustment circuit can proceed to step 513, where adjustment circuit 203 adjusts the supply voltage for the circuit in chip section 201a to that of the scaled supply voltage. In some instances, the supply voltage is providing at an initial, default value. In other instances, the supply voltage is providing a previously-scaled supply voltage. Adjustment circuit 203 can provide a control signal to components for the supply voltage such that it provides a voltage whose value is equal to that of the scaled supply voltage determined in step 511. Once the supply voltage for the circuit in chip section 201a is scaled, method 500 can end in step 515.

FIG. 6 illustrates an exemplary method for determining scaling voltages for sections of an integrated circuit. Method 600 can be performed, for example, by testing device 450 during calibration of integrated circuit 200, 410. In some embodiments, testing device 450 performs method 600 to determine scaling supply voltages for a circuit in a single chip section 201a, 411. In other embodiments, testing device 450 can perform method 600 to determine scaling supply voltages for circuits in multiple chip sections 201a-d.

Testing device 450 can begin method 600 at step 601 and can proceed to step 603, where testing control circuit 453 adjusts the operating frequency of the circuit in chip section 411. In some embodiments, testing control circuit 453 can adjust the frequency at set intervals, incrementing the operating frequency between iterations. For example, testing control circuit 453 can be configured to determine scaling supply voltages for each 100 MHz. In such instances, testing control circuit 453 in step 603 can change the frequency by 100 MHz each time testing control circuit 453 returns to that step.

In step 605, testing control circuit 453 can adjust the operating temperature of the circuit in chip section 411. In some embodiments, testing control circuit 453 can adjust the temperature at set intervals, incrementing the operating temperature between iterations. For example, testing control circuit 453 can be configured to determine scaling supply voltages for each 1° C. In such instances, testing control circuit 453 in step 605 can change the temperature by 1° C. each time testing control circuit 453 returns to step 605.

At step 607, testing device 450 can receive the operating supply voltage for the circuit in chip section 201a. In some embodiments, testing sensor 455 can measure the supply voltage for a set temperature and/or frequency and send the measured supply voltage to testing control circuit 453 and/or testing memory 457. In some instances, testing sensor 455 only sends the measured voltage; in other instances, sensor 455 can send the measured supply voltage as part of a tuple that also includes the set temperature and/or the set frequency.

Once the operating supply frequency is received in step 607, testing device 450 can proceed to step 609, where it can record the operating characteristics to scaling voltage table 300. In some embodiments, scaling voltage table 300 is included in a volatile memory portion of testing memory 457. In some embodiments, testing device 450 can write scaling constants for the scaling voltage formula such that the formula produces the scaled voltages measured in step 607.

Once operating characteristics for a specified set of values for the circuit in chip section 411 is recorded in step 609, testing device 450 can, in step 611, determine whether scaling voltages were determined for the full range of desired set temperatures. For example, if testing device 450 is to determine scaled voltages for a temperature range of 5-90° C., testing control circuit 453 can determine in step 611 whether each set temperature in the range was tested. If not, testing control circuit loops 453 loops back to step 605, where it adjusts the circuit to a new temperature. Otherwise, testing device 450 proceeds to step 613.

Testing device 450 can, in step 613, determine whether scaling voltages were determined for the full range of desired set frequencies. For example, if testing device 450 is to determine scaled voltages for a frequency range of 500 MHz-10 GHz, testing control circuit 453 can determine in step 613 whether each set frequency in the range was tested. If not, testing control circuit 453 loops back to step 603, where it adjusts the circuit to a new operating frequency. Otherwise testing device 450 proceeds to step 615.

In step 615, testing device 450 writes scaling voltage table 300 to integrated circuit 410. In some embodiments, testing device can write scaling voltage table 300 from testing memory 407 to non-volatile memory 417 in integrated circuit 410. Once testing device 450 completes the writing operation, testing device 450 can end method 600 at step 617.

It is understood that the specific order or hierarchy of steps in the processes/flow charts disclosed is an illustration of exemplary approaches. Based upon design preferences, it is understood that the specific order or hierarchy of steps in the processes/flow charts may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of providing a supply voltage to a chip, the method comprising:
measuring a temperature for a section of the chip;
determining a scaled supply voltage based on the measured temperature; and
adjusting the supply voltage for the chip section to the scaled supply voltage.

2. The method of claim 1, wherein the scaled supply voltage is further determined by an operating frequency of at least one circuit in the chip section.

3. The method of claim 1, wherein the determining a scaled voltage further comprises:
accessing a scaled voltage table; and
retrieving the scaled supply voltage associated with the measured temperature.

4. The method of claim 1, wherein the measurement of the temperature of the chip section occurs after a defined time interval.

5. The method of claim 4, wherein the defined time interval is 10 seconds.

6. The method of claim 1, wherein the scaled supply voltage is determined by:
V_{dd}=V₀+(Tₛₑₜ+Tₛₑₙₛₑ)×S
where V_{dd} is the scaled supply voltage, V₀ is a default voltage, Tₛₑₜ is a default temperature, Tₛₑₙₛₑ is a measured temperature, and S is a scaling constant.

7. The method of claim 1, further comprising:
measuring a temperature for each of a plurality of N sections of the chip, each of N measured chip section temperatures independent from the other measured chip section temperatures;
determining N scaled supply voltages, each of N scaled supply voltages based on one of N measured chip section temperatures; and
adjusting a supply voltage for each of the plurality of N chip sections to the scaled supply voltage for the chip section.

8. A method of storing measured voltages to a chip, the method comprising:
measuring an operating voltage of a section of the chip while the chip section is operating at a defined temperature;
writing the measured operating voltage and defined temperature as an entry in a scaled voltage table; and
storing, on the chip, the scaled voltage table.

9. The method of claim 8, wherein the scaled voltage table is stored into read-only memory (ROM) on the chip.

10. The method of claim 8, wherein a testing device writes the entry into the scaled voltage table.

11. The method of claim 10, further comprising:
writing, by the testing device, the scaled voltage table on the chip.

12. An integrated circuit (IC) comprising:
a chip section configured to operate using a scaled supply voltage;
a sensor configured to measure a temperature of the chip section; and
an adjustment circuit configured to adjust a supply voltage to a scaled supply voltage, wherein the scaled voltage is based on the measured temperature.

13. The apparatus of claim 12, further comprising:
a memory device comprising a scaled voltage table, wherein the adjustment circuit is configured to retrieve the scaled supply voltage from the scaled voltage table.

14. The apparatus of claim 12, wherein the scaled supply voltage is further based on an operating frequency of at least one circuit in the chip section.

15. The apparatus of claim 12, wherein the adjustment circuit is further configured to measure the chip section after a defined time interval.

16. The apparatus of claim 15, wherein the defined time interval is 10 seconds.

17. The apparatus of claim 12, wherein the adjustment circuit is configured to determine the scaled supply voltage by:
V_{dd}=V₀+(Tₛₑₜ+Tₛₑₙₛₑ)×S
where V_{dd} is the scaled voltage, V₀ is a default voltage, Tₛₑₜ is a default temperature, Tₛₑₙₛₑ is a measured temperature, and S is a scaling constant.
